(19) United States
(12) Patent Application Publication
(10) Pub. No.: US 2012/0030011 A1
(43) Pub. Date: Feb. 2, 2012

(54) Systems and Methods for Estimating a Conversion Rate for a Digital Advertisement Based on Dwell Times Associated with the Digital Advertisement

(75) Inventors: Benjamin Rey, Versailles (FR); Ashvin Kannan, Sunnyvale, CA (US)

(73) Assignee: Yahoo! Inc., Sunnyvale, CA (US)

(21) Appl. No.: 12/847,530

(22) Filed: Jul. 30, 2010

(51) Int. Cl. G06Q 30/00

(52) U.S. Cl. 705/14.43; 705/14.41

(57) ABSTRACT

The present disclosure is directed to systems and methods for estimating a conversion rate associated with a digital ad. Generally, an ad provider and/or an ad campaign management system detects an action of a user associated with a digital ad. The ad provider and/or ad campaign management system detects a subsequent action of the user after detecting the action of the user associated with the digital ad and determines an amount of time between the action of the user associated with the digital ad and the subsequent action of the user. The ad provider and/or ad campaign management system then estimates a conversion rate associated with the digital ad based on the determined amount of time. In some implementations, a model is utilized to estimate a conversion rate associated with a digital ad based on dwell times even when the ad provider and/or ad campaign management system has little or no conversion data associated with the digital ad.

### BACKGROUND

Online advertisement service providers (“ad providers”) often utilize a conversion rate associated with a digital ad, such as a banner ad or sponsored search listing, to measure a quality of the digital ad. Generally, a conversion rate associated with a digital ad measures a number users who are driven to a webpage by a digital ad that complete a specified action versus a total number of users that the digital ad drives to the website. For example, for a website selling a product, a conversion rate may measure a number of users who purchase a specific product after clicking on a digital ad versus a total number of users who click on the digital ad. However, it will be appreciated that conversion rates may apply to any specified action desired by an advertiser such as a number of users who register for a service after clicking on a digital ad versus a total number of users who click on the digital ad, or even a number of users who interact with a specific portion of a webpage after clicking on a digital ad versus a total number of users who click on the digital ad. Digital ads that are associated with a high conversion rate are often considered to be digital ads of a higher quality than digital ads associated with a low conversion rate.

It is often difficult for ad providers to track whether a user performs one or more specific actions after interacting with a digital ad unless an advertiser provides the ad provider with the conversion data. Therefore, it, is often difficult for an ad provider to accurately calculate a conversion rate associated with a digital ad and/or a calculated conversion rate may not accurately reflect a quality of a digital ad. Accordingly, it would be desirable for an ad provider to have the ability to estimate a conversion rate associated with a digital ad without relying on conversion data that an advertiser supplies to the ad provider.

### BRIEF DESCRIPTION OF THE DRAWINGS

FIG. 1 is a block diagram of an environment in which systems for estimating a conversion rate for a digital ad based on dwell times associated with the digital ad may operate;

FIG. 2 is a block diagram of a system for estimating a conversion rate for a digital ad based on dwell times associated with the digital ad;

FIG. 3 is a flow chart of a method for building a model for estimating a conversion rate for a digital ad based on dwell times associated with the digital ad; and

FIG. 4 is a flow chart of a method for estimating a conversion rate for a digital ad based on dwell times associated with the digital ad.

### DETAILED DESCRIPTION OF THE DRAWINGS

The present disclosure is directed to methods and system for estimating a conversion rate associated with a digital ad based on dwell times associated with the digital ad. Dwell time is an amount of time between a user interacting with a digital ad and a next logged action of the user. For example, dwell time may be an amount of time between a user clicking on a digital ad and a user performing an action such as clicking on a different digital ad, submitting a new search query to a search engine, or a user clicking on a portion of a webpage that does not include the digital ad. Accordingly, dwell time generally measures the amount of time that a digital ad draws the attention of a user by measuring actions such as the amount of time a user may spend interacting with a landing page associated with the digital ad.

It will be appreciated that if users spend a short amount of time on a landing page associated with a digital ad, the short dwell time may be an indication that either the landing page is not relevant to an initial search query of the user, that the landing page is not relevant to a webpage a user was previously viewing before interacting with the digital ad, and/or that the landing page is not relevant to the digital ad itself. Conversely, if a user spends a more substantial amount of time on a landing page associated with a digital ad, the more substantial amount of dwell time may be an indication that either the landing page is relevant to an initial search query of the user, that the landing page is relevant to a webpage a user was previously viewing before interacting with the digital ad, and/or that the landing page is relevant to the digital ad itself. Accordingly, there is a strong relationship between dwell times associated with a digital ad and a quality of the digital ad.

As discussed above, an inability of an ad provider to obtain consistent conversion data can sometimes lead to the ad provider calculating a conversion rate that is an inaccurate indicator of a quality of the digital ad. Therefore, in the systems and methods described below, an ad provider and/or an ad campaign management system may utilize dwell times associated with digital ads to estimate a conversion rate associated with the digital ad. The ad provider and/or ad campaign management system may then utilize the estimated conversion rate to perform operations such as optimization of the digital ad, building a click model associated with a digital ad, and/or simulating bucket testing associated with a digital ad where two or more versions of the digital ad are tested in order to measure a difference in performance of the different versions of the digital.

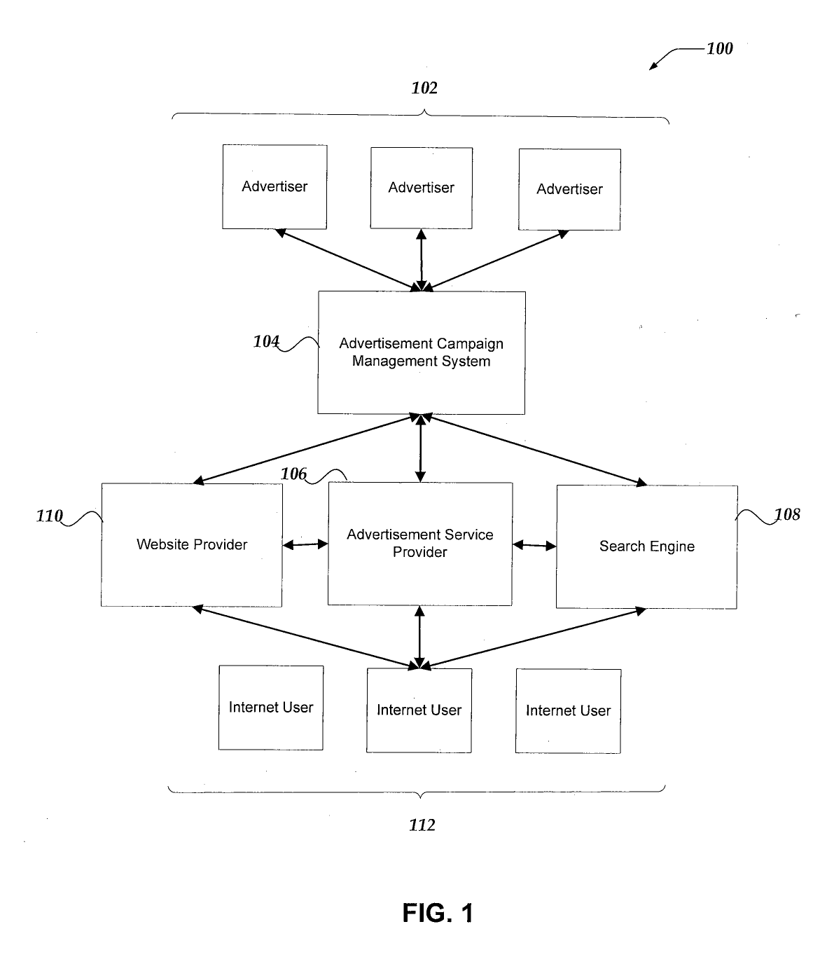

FIG. 1 is a block diagram of an environment in which a system for estimating a conversion rate for a digital ad based on dwell times associated with the digital ad may operate. The environment 100 may include a plurality of advertisers 102, an ad campaign management system 104, an ad provider 106, a search engine 108, a website provider 110, and a plurality of users 112. Generally, an advertiser 102 bids on terms and creates one or more digital ads by interacting with the ad campaign management system 104 in communication with the ad provider 106. The advertisers 102 may purchase digital ads based on an auction model of buying ad space or a guaranteed delivery model by which an advertiser pays a minimum cost-per-thousand impressions (i.e., CPM) to display the digital ad. Typically, the advertisers 102 may select—and possibly pay additional premiums for—certain targeting options, such as targeting by demographics, geography, behavior (such as past purchase patterns), “social technographics” (degree of participation in an online community) or context (page content, time of day, navigation path, etc.). The digital ad may be a graphical ad that appears on a website viewed by a user 112, a sponsored search listing that is served to a user 112 in response to a search performed at a search engine, a video ad, a graphical banner ad based on a sponsored search listing, and/or any other type of online marketing media known in the art.

When a user 112 performs a search at a search engine 108, the search engine 108 typically receives a search query comprising one or more keywords. In response to the search query, the search engine 108 returns search results including one or more search listings based on keywords within the search query provided by the user 112. Additionally, the ad provider 106 may receive a digital ad request based on the received search query. In response to the digital ad request, the ad provider 106 serves one or more digital ads created using the ad campaign management system 104 to the search engine 108 and/or the user 112 based on keywords within the search query provided by the user 112.

Similarly, when a user 112 requests a webpage served by the website provider 110, the ad provider 106 may receive a digital ad request. The digital ad request may include data such as keywords obtained from the content of the webpage. In response to the digital ad request, the ad provider 106 serves one or more digital ads created using the ad campaign management system 104 to the website provider 110 and/or the user 112 based on the keywords within the digital ad request.

When the digital ads are served, the ad campaign management system 104 and/or the ad provider 106 may record and process information associated with the served digital ads for purposes such as billing, reporting, or ad campaign optimization. For example, the ad campaign management system 104 and/or the ad provider 106 may record the factors that caused the ad provider 106 to select the served digital ads; whether the user 112 clicked on a URL or other link associated with one of the served digital ads; what additional search listings or digital ads were served with each served digital ad; a position on a webpage of a digital ad when the user 112 clicked on a digital ad; and/or whether the user 112 clicked on a different digital ad when a digital ad was served. One example of an ad campaign management system that may perform these types of actions is disclosed in U.S. patent application Ser. No. 11/413,514, filed Apr. 28, 2006, and assigned to Yahoo! Inc.

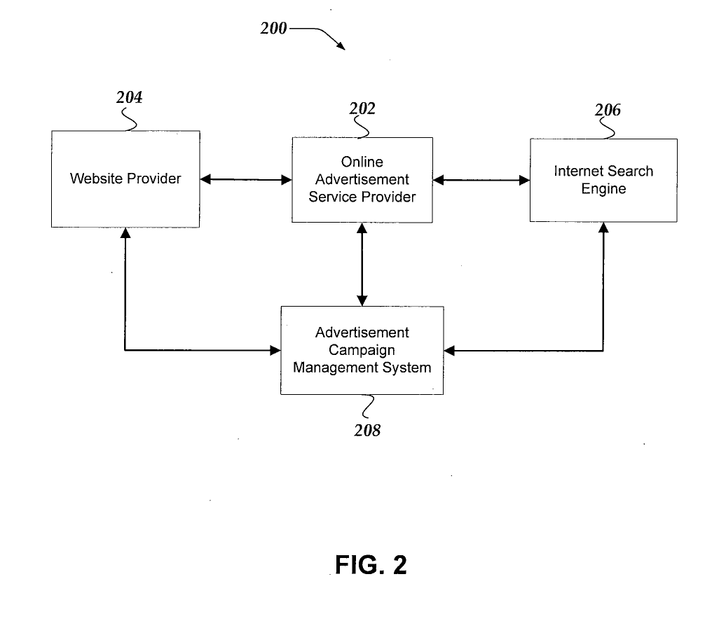

FIG. 2 is a block diagram of a system for estimating a conversion rate associated with a digital ad based on dwell time. Generally, the system 200 comprises an ad provider 202, a website provider 204, a search engine 206, and an ad campaign management system 208. In some implementations, the ad campaign management system 208 may be part of the ad provider 202, website provider 204, and/or the search engine 206, where in other implementations the ad campaign management system 208 is distinct from the ad provider 202, website provider 204, and search engine 206.

The ad provider 202, website provider 204, search engine 206, and popularity module 208 may communicate with each other over one or more external or internal networks. The networks may include local area networks (LAN), wide area networks (WAN), and/or the Internet, and may be implemented with wireless or wired communication mediums such as wireless fidelity (WiFi), Bluetooth, landlines, satellites, and/or cellular communications. Further, the ad provider 202, website provider 204, search engine 206, and/or popularity module 208 may be implemented as software code or instructions that may be stored in a tangible computer-readable storage medium, and may run in conjunction with one or more hardware processors of a single server, plurality of servers, or any other type of computing device known in the art.

Generally, after the ad provider 204 serves a digital ad in response to a digital ad request, the ad provider 204 and/or the ad campaign management system 208 monitors for actions of a user associated with the digital ad. For example, the ad campaign management system 208 may monitor for whether a user clicks on a digital ad, activates a digital ad by performing actions such as moving a cursor over a digital ad, or performs any other type of action associated with the digital ad that indicates to the ad provider 204 and/or the ad campaign management system 208 that a user is interacting with the digital ad.

After detecting an action of a user associated with the digital ad, the ad provider 204 and/or the ad campaign management system 208 monitors for a subsequent action of the user. For example, the ad provider 204 and/or the ad campaign management system 208 may monitor for whether the search engine 206 receives a new search query from the user, whether the user interacts with a different digital ad, whether a user activates a portion of a webpage that does not include the digital ad, whether a user clicks on an organic search result, or whether the user performs any other type of subsequent action that may indicate to the ad provider 204 and/or the ad campaign management system 208 that the attention of the user is no longer focused on the digital ad.

The ad provider 204 and/or the ad campaign management system 208 determines an amount of time between the action of the user associated with the digital ad and the subsequent action of the user. In some implementations, if the ad provider 204 and/or the ad campaign management system 208 fails to detect a subsequent action of the user after a defined period of time, the ad provider 204 and/or the ad campaign management system 208 associates an “infinite” dwell time between the action of the user associated with the digital ad and a subsequent action of the user. As explained in more detail below, the ad campaign management system 208 may then estimate a conversion rate associated with the digital ad based on the determined amount of time between the action of the user associated with the digital ad and the subsequent action of the user. In some implementations, the ad provider 204 and/or the ad campaign management system 208 utilizes a model to estimate a conversion rate associated with a digital ad.

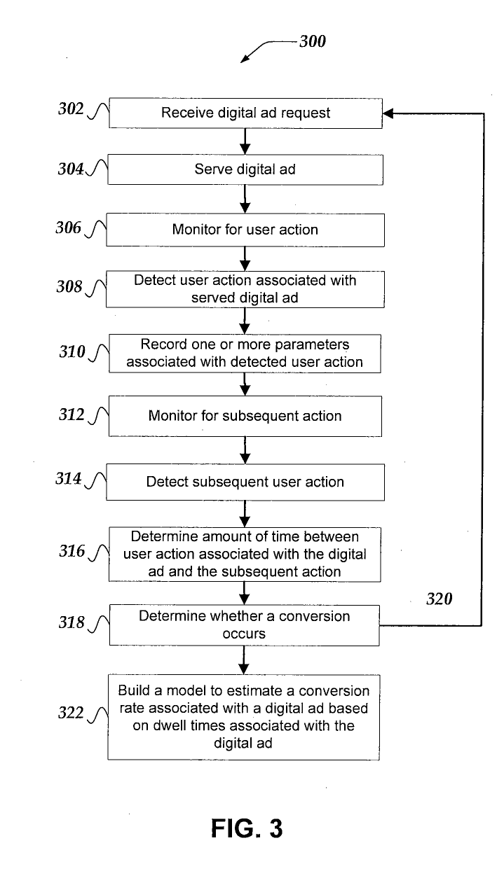

FIG. 3 is a flow chart of a method for building a model for estimating a conversion rate for a digital ad based on dwell times associated with the digital ad. The method 300 begins at step 302 with an ad provider receiving a digital ad request. The ad provider may receive the request for the digital ad based on, for example, terms in a search query that a user submits to a search engine or terms from the content of a webpage that a user requests.

The ad provider serves a digital ad in response to the digital ad request at step 304 and the ad provider and/or an ad campaign management system monitors for actions associated with the served digital ad at step 306. For example, the ad provider and/or ad campaign management system may monitor for whether a user clicks on the served digital ad and/or activates the served digital ad by performing actions such as moving a cursor over the digital.

At step 308, the ad provider and/or the ad campaign management system detects an action of a user associated with the served digital ad. In some implementations, at step 310, the ad provider and/or ad campaign management system may additionally record one or more parameters associated with the digital ad. For example, the ad provider and/or the ad campaign management system may record a specific algorithm that caused the ad provider to serve the digital ad in response to the digital ad request, a position on a webpage when the user interacts with the digital ad, a position of the digital ad with respect to other digital ads on a webpage when the user interacts with the digital ad, a time of day when the user interacts with the digital ad, a query frequency associated with a search query that caused the ad provider to serve the digital ad, a category associated with a search query that caused the ad provider to serve the digital ad, and/or any other information that may be useful to the ad provider and/or the ad campaign management system in building a model to estimate a conversion rate associated with a digital ad based on dwell times associated with the digital ad.

After detecting an action of the user associated with the served digital ad, at step 312, the ad provider and/or ad campaign management system monitors for a subsequent action of the user that generally indicates the attention of the user is no longer focused on the digital ad and/or a landing page associated with the digital ad. For example, the ad provider and/or ad campaign management system may monitor for whether the user submits a new search query to a search engine, whether the user interacts with a digital ad other than the digital ad that the user interacted with at step 308, and/or whether the user interacts with a portion of a webpage that does not include the digital ad that the user interacted with at step 308.

At step 314, the ad provider and/or ad campaign management system detects a subsequent action of the user, and at step 316, the ad provider and/or ad campaign management system determines an amount of time between the detection of the action of the user at step 308 and the detection of the subsequent action of the user at step 314.

At step 318, the ad provider and/or ad campaign management system determines whether a conversion occurs that is associated with the detected action of the user at step 308. In some implementations the ad provider and/or ad campaign management system may be able to directly determine whether a conversion occurs, where in other implementations, an advertiser informs the ad provider and/or the ad campaign management system whether a conversion occurs.

The above-described steps are repeated (loop 320) until at step 322, the ad provider and/or the ad campaign management system builds a model to estimate a conversion rate for a digital ad based on the relationships between the dwell times determined at step 316 and the associated conversions determined at step 318. In implementations where the ad provider and/or the ad campaign management system additionally record one or more parameters at step 310 that are associated with the digital ad that the user interacts with at step 308, the ad provider and/or the ad campaign management system may utilize the recorded parameters at step 322 to build the model to estimate a conversion rate associated width a digital ad. It will be appreciated that, in some implementations, the ad provider and/or the ad campaign management system may utilize machine learning algorithms and/or regression analysis techniques to build the model to estimate a conversion rate associated with a digital ad at step 322.

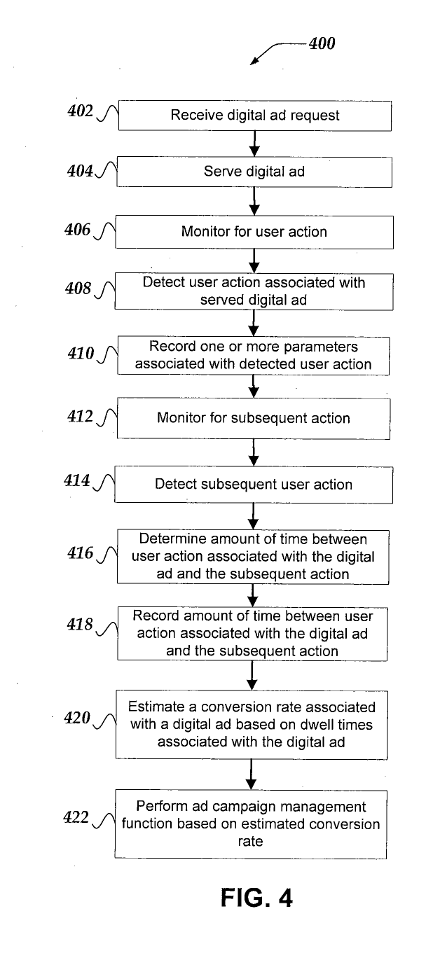

FIG. 4 is a flow chart of a method for estimating a conversion rate for a digital ad based on dwell times associated with the digital ad using a model such as the model described above with respect to FIG. 3. The method 400 begins at step 402 with an ad provider receiving a digital ad request. The ad provider may receive the request for the digital ad based on, for example, terms in a search query that a user submits to a search engine or terms from the content of a webpage that a user requests.

The ad provider serves a digital ad in response to the digital ad request at step 404 and the ad provider and/or an ad campaign management system monitors for actions associated with the served digital ad at step 406, as described above. The ad provider and/or ad campaign management system detects an action of a user associated with the served digital ad at step 408. In some implementations, as described above, the ad provider and/or the ad campaign management system may additionally record one or more parameters associated with the digital ad at step 410.

After detecting an action of the user associated with the served digital ad, at step 412, the ad provider and/or the ad campaign management system monitors for a subsequent action of the user that generally indicates the attention of the user is no longer focused on the digital ad and/or a landing page associated with the digital ad. For example, the ad provider and/or ad campaign management system may monitor for whether the user submits a new search query to a search engine, whether the user interacts with a digital ad other than the digital ad that the user interacted with at step 408, and/or whether the user interacts with a portion of a webpage that does not include the digital ad that the user interacted with at step 408.

At step 414, the ad provider and/or the ad campaign management system detects a subsequent action of the user, and at step 416, the ad provider and/or ad campaign management system determines an amount of time between the detection of the action of the user at step 408 and the detection of the subsequent action of the user at step 414. The determined amount of time may be recorded at step 418

At step 420, the ad provider and/or the ad campaign management system estimates a conversion rate associated with the digital ad based on the dwell time determined at step 416 for the digital ad using a model such as the model described above with respect to FIG. 3. Additionally, in implementations where the ad provider and/or the ad campaign management system records one or more parameters at step 410 that are associated with the digital ad that the user interacts with at step 408, the ad provider and/or the ad campaign management system may additionally utilize the one or more recorded parameters in addition to the dwell time determined at step 416 when applying a model to estimate the conversion rate associated with the digital ad.

At step 422, the ad provider and/or the ad campaign management system may utilize the estimated conversion rate to perform ad campaign management operations such as optimizing the digital ad, incorporating the conversion prediction into the click model for the digital ad, accurately measuring the conversion rate even on small bucket tests associated with the digital ad, directly influencing the position and/or pricing of the digital ad, and/or any other type of operation the ad campaign management system may desire to perform based on an estimated conversion rate. For example, in order to optimize a digital ad to change the position and/or pricing of the digital ad, the ad provider and/or ad campaign management system may automatically adjust a parameter such as a bid value, keyword, and/or target demographic parameter associated with the digital ad based on the click model in order to align the predicted performance of the digital ad with preferences that an advertiser has previously associated with the digital ad.

FIGS. 1-4 disclose systems and methods for estimating a conversion rate associated with a digital ad based on dwell times associated with the digital ad. As discussed above, by utilizing the relationships between dwell times of a digital ad and a quality and/or relevance of the digital ad, ad providers and/or ad campaign management systems are able to use the amount of time that a digital ad draws the attention of a user to accurately estimate a conversion rate associated with the digital ad when advertisers do not directly provide ad providers and/or ad campaign management systems with conversion data. Ad providers and/or ad campaign management systems may utilize the estimated conversion rate to perform ad campaign management operations or to accurately measure a conversion rate of digital ads based on small slices of traffic such as traffic measured during a bucket test or traffic present in markets associated with lower internet searches/display volume such as emerging markets.

It is intended that the foregoing detailed description be regarded as illustrative rather than limiting, and that it be understood that it is the following claims, including all equivalents, that are intended to define the spirit and scope of this invention.

1. A method for estimating a conversion rate associated with a digital ad, the method comprising:
detecting an action of a user associated with a digital ad;
detecting a subsequent action of the user after detecting the action of the user associated with the digital ad;
determining an amount of time between the action of the user associated with the digital ad and the subsequent action of the user; and
estimating a conversion rate associated with the digital ad based on the determined amount of time between the action of the user associated with the digital ad and the subsequent action of the user.

2. The method of claim 1, further comprising:
recording one or more parameters associated with the detection of the action of the user associated with the search listing; and
building a click model based on the estimation of the conversion rate associated with the digital ad and the one or more parameters associated with the detection of the action of the user.

3. The method of claim 1, further comprising:
optimizing the digital ad based on the estimated conversion rate.

4. The method of claim 1, wherein detecting an action of a user associated with a digital ad comprises:
detecting that a user clicks on a digital ad.

5. The method of claim 1, wherein detecting a subsequent action of the user comprises:
receiving a search query from the user.

6. The method of claim 1, wherein detecting a subsequent action of the user comprises:
detecting that a user clicks on a second digital ad.

7. The method of claim 1, wherein detecting a subsequent action of the user comprises:
detecting that a user interacts with a portion of a webpage that does not include the digital ad.

8. The method of claim 1, further comprising:
building a model to estimate a conversion rate associated with the digital ad based on the determination of the amount of time between the action of the user associated with the search listing and the subsequent action of the user;
wherein estimating a conversion rate associated with the digital ad comprises:
estimating a conversion rate associated with the digital ad based on the model and the determined amount of time between the action of the user associated with the search listing and the subsequent action of the user.

9. The method of claim 1, further comprising:
recording one or more parameters associated with the detection of the action of the user associated with the search listing;
wherein estimating a conversion rate associated with the digital ad comprises:
estimating a conversion rate associated with the digital ad based on at least one of the one or more parameters and the determined amount of time between the action of the user associated with the digital ad and the subsequent action of the user.

10. The method of claim 9, wherein the one or more parameters comprises at least one of:
a type of matching algorithm that caused an ad provider to serve the digital ad in response to a digital ad request;
a position of the digital ad on a webpage when the action of the user associated with the digital ad is detected;
a time of day when the action of the user associated with the digital ad is detected;
a query frequency associated with a search query that caused an ad provider to serve the digital ad; or
a category associated with a search query that caused an ad provider to serve the digital ad.

11. A computer-readable storage medium comprising a set of instructions for estimating a conversion rate associated with a digital ad, the set of instructions to direct a processor to perform acts of:
detecting an action of a user associated with a digital ad;
detecting a subsequent action of the user after detecting the action of the user associated with the digital ad;
determining an amount of time between the action of the user associated with the digital ad and the subsequent action of the user; and
estimating a conversion rate associated with the digital ad based on the determined amount of time between the action of the user associated with the digital ad and the subsequent action of the user.

12. The computer-readable storage medium of claim 11, further comprising a set of instructions to direct a processor to perform acts of:
recording one or more parameters associated with the detection of the action of the user associated with the search listing; and
building a click model based on the estimation of the conversion rate associated with the digital ad and the one or more parameters associated with the detection of the action of the user.

13. The computer-readable storage medium of claim 11, further comprising a set of instructions to direct a processor to perform acts of:
optimizing the digital ad based on the estimated conversion rate.

14. The computer-readable storage medium of claim 11, further comprising a set of instructions to direct a processor to perform acts of:
building a model to estimate a conversion rate associated with the digital ad based on the determination of the amount of time between the action of the user associated with the digital ad and the subsequent action of the user;
wherein estimating a conversion rate associated with the digital ad comprises:
estimating a conversion rate associated with the digital ad based on the model and the determined amount of time between the action of the user associated with the digital ad and the subsequent action of the user.

15. The computer-readable storage medium of claim 11, further comprising a set of instructions to direct a processor to perform acts of:
recording one or more parameters associated with the detection of the action of the user associated with the search listing;
wherein estimating a conversion rate associated with the digital ad comprises:
estimating a conversion rate associated with the digital ad based on at least one of the one or more parameters and the determined amount of time between the action of the user associated with the digital ad and the subsequent action of the user.

16. A system for estimating a conversion rate associated with a digital ad, the system comprising:
an advertisement campaign management system comprising a memory and a processor configured to execute instructions stored in the memory, the advertisement campaign management system configured to:
detect an action of a user associated with a digital ad;
detect a subsequent action of the user after the detection of the action of the user associated with the digital ad;
determine an amount of time between the action of the user associated with the digital ad and the subsequent action of the user; and
estimate a conversion rate associated with the digital ad based on the determined amount of time between the action of the user associated with the digital ad and the subsequent action of the user.

17. The system of claim 16, wherein the advertisement campaign management system is further configured to:
record one or more parameters associated with the detection of the action of the user associated with the search listing; and
build a click model based on the estimation of the conversion rate associated with the digital ad and the one or more parameters associated with the detection of the action of the user

18. The system of claim 16, wherein the advertisement campaign management system is further configured to:
optimize the digital ad based on the estimated conversion rate.

19. The system of claim 16, wherein the advertisement campaign management system is further configured to build a model to estimate a conversion rate associated with the digital ad based on the determination of the amount of time between the action of the user associated with the search listing and the subsequent action of the user;
wherein to estimate a conversion rate associated with the digital ad, the advertisement campaign management system is configured to estimate a conversion rate associated with the digital ad based on the model and the determined amount of time between the action of the user associated with the search listing and the subsequent action of the user.

20. The system of claim 16, wherein the advertisement campaign management system is further configured to record one or more parameters associated with the detection of the action of the user associated with the search listing;
wherein to estimate a conversion rate associated with the digital ad, the advertisement campaign management system is configured to estimate a conversion rate associated with the digital ad based on at least one of the one more parameters and the determined amount of time between the action of the user associated with the digital ad and the subsequent action of the user.
